(19) United States
(12) Patent Application Publication
(10) Pub. No.: US 2023/0346026 A1
(43) Pub. Date: Nov. 2, 2023

(54) AEROSOL GENERATING DEVICE AND INFRARED EMITTER

(71) Applicant: SHENZHEN FIRST UNION TECHNOLOGY CO., LTD., Shenzhen, Guangdong (CN)

(72) Inventors: DONGJUN YAN, Shenzhen City, Guangdong Province (CN); RUILONG HU, Shenzhen City, Guangdong Province (CN); WENJUAN LI, Shenzhen City, Guangdong Province (CN); JIAN WU, Shenzhen City, Guangdong Province (CN); ZUQIANG QI, Shenzhen City, Guangdong Province (CN); BAOLING LEI, Shenzhen City, Guangdong Province (CN); LINHAI LU, Shenzhen City, Guangdong Province (CN); ZHONGLI XU, Shenzhen City, Guangdong Province (CN); YONGHAI LI, Shenzhen City, Guangdong Province (CN)

(21) Appl. No.: 17/793,313

(22) PCT Filed: Jan. 15, 2021
(86) PCT No.: PCT/CN2021/072140

§ 371 Date: Jul. 15, 2022

(30) Foreign Application Priority Data
Jan. 15, 2020 (CN) 202010041097.6

(51) Int. Cl. A24F 40/46; A24F 40/20; H05B 3/54

(52) U.S. Cl. CPC A24F 40/46; A24F 40/20; H05B 3/54; H05B 2203/013; H05B 2203/032

(57) ABSTRACT

The present application provides an aerosol generating device and an infrared emitter. The aerosol generating device comprises: a cavity, being configured to receive a smokable material; an infrared emission thin film, being configured to radiate infrared rays to the cavity so as to heat the smokable material. The aerosol generating device and the infrared emitter described above adopt thin film formation capable of radiating infrared rays to heat the smokable material, and the thin film may be conveniently obtained and then wound for fixation, which is more convenient in production and preparation as well as disassembly and replacement during use as compared to the infrared emitter with printed coating.

### CROSS-REFERENCE TO RELATED APPLICATION

The present application claims priority to Prior Application No. 202010041097.6, filed with the State Intellectual Property Office of China on Jan. 15, 2020, titled “AEROSOL GENERATING DEVICE AND INFRARED EMITTER”, the contents of which are incorporated herein by reference.

### TECHNICAL FIELD

Embodiments of the present application relate to the technical field of smoking sets which are incombustible when heated, and in particular, relate to an aerosol generating device and an infrared emitter.

### BACKGROUND

Tobacco products (e.g., cigarettes, cigars, etc.) burn tobacco to produce tobacco smoke during use. Attempts have been made to replace these tobacco-burning products by manufacturing products that release compounds without burning.

An example of such products is a heating device, which release compounds by heating instead of burning a material. For example, the material may be tobacco or other non-tobacco products, and these non-tobacco products may or may not contain nicotine. As another example, an infrared heating device is currently available that heats tobacco products by infrared radiation so that the tobacco products release compounds to generate aerosol. Specifically, China Patent No. 201821350103.0 proposes a heating device structure in which a nano-far infrared coating and a conductive coating are sequentially formed on the outer surface of a quartz tube. After the conductive coating is connected with a battery for supplying power, the nano-far infrared coating generates heat by itself when it is supplied with power, and at the same time, it forms electronic transition to generate far infrared which is radiated on tobacco products in the quartz tube to heat the tobacco products. In the preparation of the above known devices, it is necessary to print multiple layers of coatings on the quartz tube, which is inconvenient for production and preparation as well as replacement during use.

### SUMMARY

In order to solve the problem of inconvenient production, preparation and replacement of the aerosol generating device in the prior art, an embodiment of the present application provides an aerosol generating device and an infrared emitter which are convenient for production and preparation.

An embodiment of the present application provides an aerosol generating device which is configured to heat a smokable material to generate aerosol for inhalation; and the aerosol generating device comprises:
a cavity, being configured to receive a smokable material;
an infrared emission thin film, being configured to radiate infrared rays to the cavity so as to heat the smokable material;
a base, being configured to support the infrared emission thin film.

In a more preferred embodiment, the infrared emission thin film is configured to extend along the axial direction of the cavity and at least partially surround the cavity.

In a more preferred embodiment, the infrared emission thin film is an electro-infrared emission thin film.

In a more preferred embodiment, the infrared emission thin film comprises at least one of a zinc oxide thin film, an indium oxide or tin oxide thin film doped with rare earth elements, and a graphene thin film.

In a more preferred embodiment, the thickness of the infrared emission thin film ranges from 30 nm to 500 nm.

In a more preferred embodiment, the infrared emission thin film comprises:
a flexible substrate;
an infrared emission layer formed on the flexible substrate.

In a more preferred embodiment, the flexible substrate comprises at least one of polyimide, flexible glass or ceramic paper.

In a more preferred embodiment, the base is configured into a tubular shape extending along the axial direction of the cavity and surrounding the cavity, and the infrared emission thin film is wound around at least a part of the outer surface of the base.

In a more preferred embodiment, the aerosol generating device further comprises:
a holding element, being configured to extend along the axial direction of the base and at least partially surround the infrared emission thin film, and being configured to provide support for the infrared emission thin film; wherein the infrared emission thin film is wound around the outer surface of the base under the support of the holding element.

In a more preferred embodiment, the holding element is configured into a tubular shape located outside the infrared emission thin film along the radial direction of the base.

In a more preferred embodiment, an infrared reflecting layer is formed on the surface of the infrared emission thin film opposite to the cavity.

In a more preferred embodiment, a conductive coating for supplying power to the infrared emission thin film is formed on the infrared emission thin film.

In a more preferred embodiment, the infrared emission thin film comprises at least a first area and a second area which are capable of being independently controlled, so as to independently radiate infrared rays to the cavity to heat different parts of the smokable material.

In a more preferred embodiment, the conductive coating comprises at least a first conductive coating, a second conductive coating and a third conductive coating which are arranged at intervals in sequence, and the infrared emission thin film is divided into a first area between the first conductive coating and the second conductive coating and a second area between the second conductive coating and the third conductive coating.

In a preferred embodiment, the first conductive coating, the second conductive coating and the third conductive coating extend along the axial direction of the cavity and are sequentially arranged at intervals along the circumferential direction of the cavity, so that the infrared emission thin film is divided into a first area and a second area which are sequentially arranged along the circumferential direction of the cavity.

Alternatively, in yet another preferred embodiment, the first conductive coating, the second conductive coating and the third conductive coating extend along the circumferential direction of the cavity and are sequentially arranged at intervals along the axial direction, so that the infrared emission thin film is divided into a first area and a second area which are sequentially arranged along the axial direction of the cavity.

An embodiment of the present application further provides an infrared emitter for an aerosol generating device, which comprises:
a base;
an infrared emission thin film, bonded to at least a part of the surface of the base.

The aerosol generating device and the infrared emitter described above adopt thin film formation capable of radiating infrared rays to heat the smokable material, and the thin film may be conveniently obtained and then wound for fixation, which is more convenient in production and preparation as well as disassembly and replacement during use as compared to the infrared emitter with printed coating.

### BRIEF DESCRIPTION OF THE DRAWINGS

One or more embodiments are illustrated by pictures in corresponding attached drawings, and this does not constitute limitation on the embodiments. Elements with the same reference numerals in the attached drawings are shown as similar elements, and the pictures in the attached drawings do not constitute scale limitation unless otherwise stated specifically.

FIG. 1 is a schematic view of an aerosol generating device provided according to an embodiment.

FIG. 2 is a schematic cross-sectional view of the aerosol generating device shown in FIG. 1.

FIG. 3 is a schematic view of one embodiment of an infrared transmitter in FIG. 2.

FIG. 4 is an expanded schematic view of the infrared emission thin film in FIG. 3 after it is unfolded.

FIG. 5 is a schematic view of an infrared transmitter of yet another embodiment.

FIG. 6 is a schematic view of an infrared emission thin film of yet another embodiment.

FIG. 7 is a schematic view of an infrared emission thin film of yet another embodiment.

FIG. 8 is a schematic view of an infrared emission thin film of yet another embodiment.

FIG. 9 is a schematic view of the infrared emission thin film of FIG. 8 being wound to form an infrared emitter.

FIG. 10 is a schematic view of an infrared emission thin film of yet another embodiment.

FIG. 11 is a schematic view of an infrared transmitter of yet another embodiment.

FIG. 12 is a schematic view of an infrared emission thin film of yet another embodiment.

### DETAILED DESCRIPTION

In order to facilitate the understanding of the present application, the present application will be described in more detail below with reference to the attached drawings and detailed description.

One embodiment of the present application provides an aerosol generating device for heating instead of burning a smokable material, such as cigarettes, so as to volatilize or release at least one component of the smokable material to form aerosol for inhalation.

Based on a preferred embodiment, the aerosol generating device heats the smokable material by radiating far infrared rays with the heating effect e.g., far infrared rays of 3 μm to 15 μm. When the wavelength of the infrared rays matches the absorption wavelength of the volatile component of the smokable material during use, the energy of the infrared rays is easily absorbed by the smokable material, and then the smokable material is heated to volatilize at least one volatile component thereof to generate aerosol for inhalation.

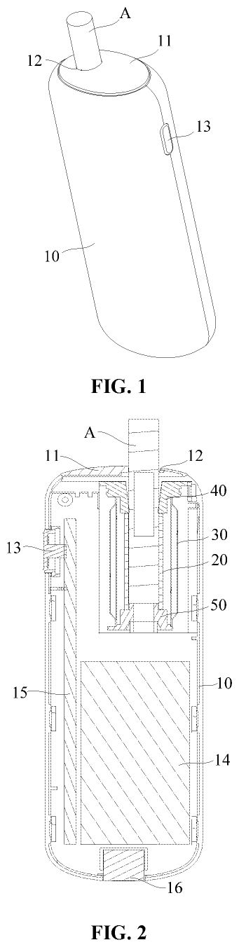

Reference may be made to FIG. 1 to FIG. 2 for the structure of an aerosol generating device according to an embodiment of the present application. The overall shape of the device is generally configured in a flat cylinder shape, and external components of the aerosol generating device include:

a housing 10, which is hollow inside so as to form an assembly space for accommodating necessary functional components such as infrared radiation or the like;

an upper cover 11 located at the upper end of the housing 10 in the length direction; on the one hand, the upper cover 11 may cover the upper end of the housing 10 so that the appearance of the aerosol generating device is complete and beautiful; and on the other hand, the upper cover 11 is detachable from the upper end of the housing 10, thereby facilitating the installation, detachment and replacement of various functional components in the housing 10.

As can be further seen from FIG. 1 and FIG. 2, the upper cover 11 has an opening 12 through which the smokable material A may be at least partially received in the housing 10 along the length direction of the housing 10 to be heated, or the smokable material A may be removed from the housing 10 through the opening 12.

The housing 10 is further provided with a switch button 13 on one side in the width direction, and a user may manually actuate the switch button 13 to control the start or stop of the aerosol generating device.

Further referring to FIG. 2, the housing 10 is provided therein with:
a battery cell 14 for power supply;
a control circuit board 15 with an integrated circuit for controlling the operation of the aerosol generating device;
a charging interface 16 for charging the battery cell 14, such as a USB type-C interface or a Pin interface or the like, which is capable of charging the battery cell 14 after being connected to an external power supply or adapter.

Further referring to FIG. 2, in order to heat the smokable material A, an infrared emitter 20 is arranged in the housing 10. The infrared emitter 20 is an electro-infrared emitter which is configured to radiate infrared rays to the smokable material A received in the housing 10 when the battery cell 14 supplies power, thereby heating the smokable material A.

In the preferred embodiment shown in FIG. 2, the aerosol generating device further comprises a heat insulator 30 arranged outside the infrared emitter 20 in the radial direction. In a more preferred embodiment, the heat insulator 30 comprises a vacuum insulation tube or the like having an internal vacuum area.

Further referring to FIG. 2, the aerosol generating device further comprises an upper support 40 and a lower support 50, both of which are in hollow annular shapes. The upper support 40 and the lower support 50 respectively support two ends of the infrared emitter 20 and the heat insulator 30 so that the infrared emitter 20 and the heat insulator 30 are stably maintained in the housing 10.

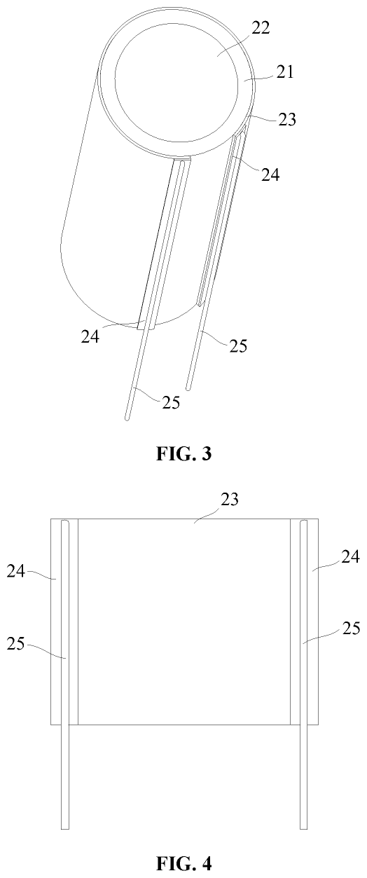

Further referring to a preferred embodiment shown in FIG. 3, the structure of the infrared emitter 20 may comprise:
a tubular base 21, which, as a rigid carrier and an object containing the smokable material A, may be made of high-temperature resistant and infrared-transmitting materials such as quartz glass, ceramics or mica in an embodiment; the tubular base 21 is preferably made of a transparent material, for example, a high-temperature resistant material with infrared transmittance above 95%; and during use, at least a part of the tubular hollow space of the tubular base 21 forms the cavity 22 for receiving the smokable material A; and
an infrared emission thin film 23 bonded to the outer surface of the tubular base 21 by winding; the infrared emission thin film 23 is an electro-infrared emission thin film; the material of the infrared emission thin film 23 may be a zinc oxide thin film with infrared emission function, an indium oxide or tin oxide thin film doped with rare earth elements such as yttrium (Y), scandium (Sc), neodymium (Nd) and cerium (Ce) for adjusting infrared emission efficiency and wavelength, a graphene thin film or the like, and the thickness thereof is usually about 30 nm to 500 nm.

Further referring to FIG. 3 and FIG. 4, in order to make it convenient to supply power to the infrared emission thin film 23, conductive coatings 24 used as electrodes are formed on both sides of the infrared emission thin film 23, and the materials of the conductive coatings 24 may be low-resistivity metals or alloys, such as silver, gold, palladium, platinum, copper, nickel, molybdenum, tungsten, niobium or an alloy material of the above-mentioned metals. In a specific embodiment, the method of forming the above conductive coatings 24 on the surface of the infrared emission thin film 23 may be as follows: the powder of the alloy material of the above metals is mixed with an organic solvent or an auxiliary agent to prepare slurry, which is then printed or coated on the surface of the infrared emission thin film 23 by printing or coating, and then cured to obtain the above conductive coatings 24.

Meanwhile, in order to make it convenient for the conductive coating 24 to be used subsequently as an electrode for supplying power to the infrared emission thin film 23, the conductive coating 24 is further formed thereon with elongated conductive pins 25 by welding or the like, and the conductive pins 25 are connected to the positive and negative electrodes of the battery cell 14.

In yet another preferred embodiment, referring to FIG. 5, in order to make it convenient for the flexible infrared emission thin film 23 to be closely attached to the outer surface of the tubular base 21 during use, in a preferred embodiment, a rigid tubular holding element 27 may be sleeved outside the infrared emission thin film 23 in the radial direction to tightly press the infrared emission thin film 23 against the outer surface of the tubular base 21.

In addition to the above winding method of the tubular base 21, in other variant embodiments, the infrared emission thin film 23 may also be clamped or held on a sheet-like base or a base with certain arc bending.

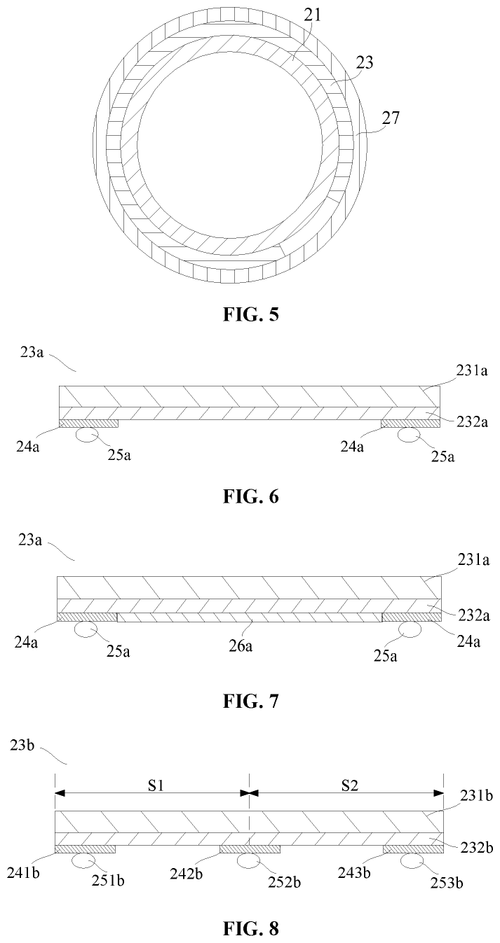

In other variant embodiments, the structure of the infrared emission thin film 23a shown in FIG. 6 comprises:
a flexible substrate 231a, serving as a substrate for subsequent loading of infrared emission materials, and being made of a flexible material that is favorable for being wound around the outer surface of the tubular base 21 subsequently; wherein the material selected may be flexible glass, a PI film, flexible ceramic paper or the like;
an infrared emission layer 232a formed on the surface of the flexible substrate 231a by printing or deposition or other processes; in an embodiment, the infrared emission layer 232a may be obtained by depositing and curing materials capable of emitting infrared rays on the surface of the flexible substrate 231a by spraying, or scrape coating, spin coating, roller coating, physical or chemical vapor deposition or the like; in an embodiment, the material of the infrared emission layer 232a may be composed of oxides of at least one metal element such as Mg, Al, Ti, Zr, Mn, Fe, Co, Ni, Cu, Cr, Zn or the like. These metal oxides can radiate far infrared rays with heating effect when heated to a suitable temperature, and the thickness of these metal oxides is preferably controlled to range from 30 μm to 50 μm;
conductive coatings 24a further formed on the two sides of the surface of the infrared emission layer 232a, wherein conductive pins 25a are welded for subsequent conductive connection with the positive and negative electrodes of the battery cell 14, so as to supply power to the infrared emission layer 232a so that the infrared emission layer 232a radiates infrared rays.

During use, in order to improve the infrared utilization efficiency, in the preferred embodiment of the infrared emission thin film 23a shown in FIG. 7, an infrared reflecting layer 26a may be further formed on the outer surface of the infrared emission layer 232a shown in FIG. 6. After the infrared reflecting layer 26a is wound around the outer surface of the tubular base 21, the infrared rays radiated from the infrared emission thin film 23a in the radial direction may be reflected back into the cavity 22 in the tubular base 21 to heat the smokable material. In a preferred embodiment, the infrared emission layer 232a may be made of one or more of gold, silver, nickel, aluminum, gold alloy, silver alloy, nickel alloy, aluminum alloy, gold oxide, silver oxide, nickel oxide and aluminum oxide, titanium oxide, zinc oxide and cerium dioxide, and the thickness thereof is between 0.3 μm and 200 μm.

In yet another preferred embodiment, an infrared emission thin film 23b having an area capable of independently radiating infrared rays along the circumferential direction of the tubular base 21 may be further proposed. Specifically, referring to FIG. 8, the infrared emission thin film 23b comprises:
a flexible substrate 231b, and an infrared emission layer 232b formed on the flexible substrate 231b;
a first conductive coating 241b, a second conductive coating 242b, and a third conductive coating 243b formed at both sides and the center of the infrared emission layer 232b in the width direction; wherein a first conductive pin 251b, a second conductive pin 252b, and a third conductive pin 253b are further formed by welding so that the infrared emission layer 232b is divided into a first area S1 between the first conductive pin 251b and the second conductive pin 252b, and a second area S2 between the second conductive pin 252b and the third conductive pin 253b.

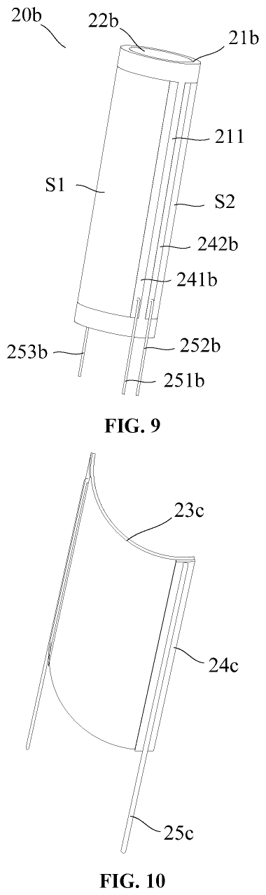

The structure of an infrared emitter 20b formed by further winding the infrared emission thin film 23b outside the tubular base 21b is shown in FIG. 9. During use, the first conductive pin 251b and the second conductive pin 252b may be conductively connected with the positive and negative electrodes of the battery cell 14 independently, or the second conductive pin 252b and the third conductive pin 253b may be conductively connected with the positive and negative electrodes of the battery cell 14 independently, so that the first area S1 or the second area S2 may be independently supplied with power. During use, infrared rays may be radiated independently or simultaneously so that part or all of the smokable material A is heated.

It shall be noted that, in the preferred embodiments shown in FIG. 8 and FIG. 9 above, the second conductive pin 252b and the second conductive coating 242b are used as common electrodes when the first area S1 and the second area S2 are independently supplied with power. Alternatively, in other variant embodiments, a plurality of infrared emission thin films 23c with conductive coatings 24c and conductive pins 25c on both ends shown in FIG. 10 may be attached on the outer surface of the tubular base 21 sequentially in the circumferential direction, and independent power supply can be realized simply by connecting the respective conductive pins 25c of the infrared emission thin films 23c with the positive and negative electrodes of the battery cell 14 without the need for common pins.

Alternatively, in other variant embodiments, as shown in FIG. 11, an infrared emitter 20d may be attached or bonded to a tubular base 21d, the outer surface of the tubular base 21d is attached with a plurality of infrared emission thin films 231d/232d/233d arranged in the circumferential direction, and a plurality of conductive coatings 241d/242d/243d/244d/245d/246d which are conductively connected with the infrared emission thin films 231d/232d/233d correspondingly are arranged at both ends of the tubular base 21d in the length direction. During use, conductive pins are respectively welded on the conductive coatings 241d/242d/243d/244d/245d/246d at both ends and then conductively connected with the positive and negative electrodes of the battery cell 14, so that the infrared emission thin films 231d/232d/233d may be independently supplied with power to independently radiate infrared rays for heating.

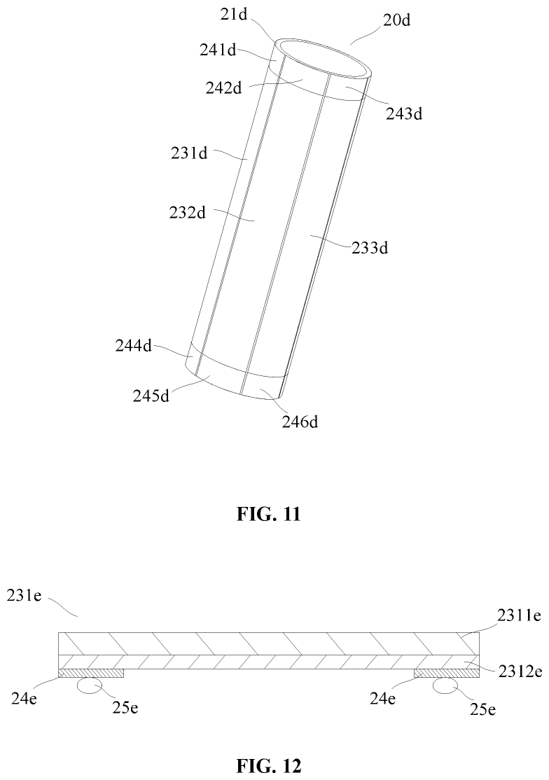

In yet another preferred variant embodiment, as shown in FIG. 12, an infrared emission thin film 231e is a composite multilayer film layer, which specifically comprises a thermally induced infrared emission layer 2311e and a heating layer 2312e bonded to the infrared emission layer 2311e. The heating layer 2312e may generate heat and transfer heat to the infrared emission layer 2311e under the power supply through the electrode coating 24e and the conductive pin 25e to heat the infrared emission layer 2311e, and the infrared emission layer 2311e radiates infrared rays to heat the smokable material A when it is heated.

It shall be noted that, the specification and attached drawings of the present application show preferred embodiments of the present application. However, the present application is not limited to the embodiments described in this specification. Further speaking, those of ordinary skill in the art can make improvements or variations according to the above description, and all these improvements and variations shall fall within the scope claimed in the appended claims of the present application.

1. An aerosol generating device for heating a smokable material to generate aerosol for inhalation; comprising:
a cavity, being configured to receive a smokable material;
an infrared emission thin film, being configured to radiate infrared rays to the cavity so as to heat the smokable material;
a base, being configured to support the infrared emission thin film.

2. The aerosol generating device according to claim 1, wherein the infrared emission thin film is configured to extend along the axial direction of the cavity and at least partially surround the cavity.

3. The aerosol generating device according to claim 1, wherein the infrared emission thin film is an electro-infrared emission thin film.

4. The aerosol generating device according to claim 1, wherein the infrared emission thin film comprises at least one of a zinc oxide thin film, an indium oxide or tin oxide thin film doped with rare earth elements, and a graphene thin film.

5. The aerosol generating device according to claim 4, wherein the thickness of the infrared emission thin film ranges from 30 nm to 500 nm.

6. The aerosol generating device according to claim 1, wherein the infrared emission thin film comprises:
a flexible substrate;
an infrared emission layer formed on the flexible substrate.

7. The aerosol generating device according to claim 6, wherein the flexible substrate comprises at least one of polyimide, flexible glass or ceramic paper.

8. The aerosol generating device according to claim 1, wherein the base is configured into a tubular shape extending along the axial direction of the cavity and surrounding the cavity, and the infrared emission thin film is wound around at least a part of the outer surface of the base.

9. The aerosol generating device according to claim 8, wherein further comprising:
a holding element, being configured to extend along the axial direction of the base and at least partially surround the infrared emission thin film, and being configured to provide support for the infrared emission thin film; wherein the infrared emission thin film is wound around the outer surface of the base under the support of the holding element.

10. The aerosol generating device according to claim 9, wherein the holding element is configured into a tubular shape located outside the infrared emission thin film along the radial direction of the base.

11. The aerosol generating device according to claim 1, wherein the infrared emission thin film comprises:
a heating layer;
an infrared emission layer formed on the heating layer, being configured to receive the heat transferred by the heating layer, and radiate infrared rays to the cavity to heat the smokable material when heated by the heating layer.

12. The aerosol generating device according to claim 1, wherein an infrared reflecting layer is formed on the surface of the infrared emission thin film opposite to the cavity.

13. The aerosol generating device according to claim 1, wherein a conductive coating for supplying power to the infrared emission thin film is formed on the infrared emission thin film.

14. The aerosol generating device according to claim 13, wherein the infrared emission thin film comprises at least a first area and a second area which are capable of being independently controlled, so as to independently radiate infrared rays to the cavity to heat different parts of the smokable material.

15. The aerosol generating device according to claim 13, wherein the conductive coating comprises at least a first conductive coating, a second conductive coating and a third conductive coating which are arranged at intervals in sequence, and the infrared emission thin film is divided into a first area between the first conductive coating and the second conductive coating and a second area between the second conductive coating and the third conductive coating.

16. An infrared emitter for an aerosol generating device, comprising:
a base;
an infrared emission thin film, bonded to at least a part of the surface of the base.
